(19) United States
(12) Patent Application Publication
(10) Pub. No.: US 2026/0043665 A1
(43) Pub. Date: Feb. 12, 2026

(54) Real Time Event Reporting With Contextual Information Along Navigable Routes

(71) Applicant: Google LLC, Moutain View, CA (US)

(72) Inventors: Tomasz Mikolajewski, Chatswood (AU); Sudhir Mandarapu, Marrickville (AU); Vivian Shen, Croydon (AU); Brendan Paul Haesler, Camperdown (AU)

(21) Appl. No.: 18/916,212

(22) Filed: Oct. 15, 2024

Related U.S. Application Data
(60) Provisional application No. 63/680,295, filed on Aug. 7, 2024.

(51) Int. Cl. G01C 21/36; G01C 21/34

(52) U.S. Cl. CPC G01C 21/3608; G01C 21/3484; G01C 21/367; G01C 21/3679

(57) ABSTRACT

Aspects of the technology relate to real time event tracking for generating and providing summaries of events reported by users along navigable routes. An example real time event can be a traffic event that is observed by a user navigating along a route provided by a navigation system. The tracking system can receive verbal descriptions of events and contextual information for a navigable route on which a user computing device in communication with the tracking system may be operated. Contextual information can be any type of information relating to the navigable route, for example previous maneuvers or upcoming maneuvers. User input may be received while a user is operating a vehicle or otherwise preoccupied and the tracking system avoids complicated and information-dense user interfaces with various predetermined user-interactable elements for event types that may be slow or hazardous to interact with and use to report an event in real time.

### CROSS-REFERENCE TO RELATED APPLICATIONS

This application claims the benefit under 35 U.S. C. § 119(e) of the filing date of U.S. patent application Ser. No. 63/680,295, for REAL TIME EVENT REPORTING WITH CONTEXTUAL INFORMATION ALONG NAVIGABLE ROUTES, which was filed on Aug. 7, 2024, and which is incorporated here by reference.

### BACKGROUND

Map navigation systems are used in many different situations, including when providing driving or walking directions to a user. In the case of driving, the navigation system can adapt to current traffic conditions to alter the route or help a user make a decision on taking a detour, for example based on the knowledge of road closures, traffic jams or accidents. This information may be received from third party reports, e.g., crowdsourced from other drivers, local transit authorities, etc. These reports are limited, in that map navigation software interfaces implement user-interactable elements for reporting different types of events. Further, adding elements for reporting more event types can clutter user interfaces, making user interfaces harder and less safe for interacting with through touch input, especially while also operating a vehicle.

### BRIEF SUMMARY

Aspects of the disclosure are directed to a real time event tracking system for generating and providing summaries of events reported by users along navigable routes. An example real time event can be a traffic event that is observed by a user navigating along a route provided by a navigation system. The tracking system can receive verbal descriptions of events encountered by a user, for example while operating a vehicle. Given that user input may be received while a user is operating a vehicle or is otherwise preoccupied, the tracking system as described herein avoids complicated and information-dense user interfaces. To that end, the system reduces or eliminates the need for user-interactable elements for event types that may be slow or hazardous to interact with and use to report an event in real time.

Contextual information can be received alongside a verbal description and can be used to improve the accuracy or clarity of the output of the tracking system at various stages in the pipeline, for example to improve event classification, spam identification, summarization of a reported real time event, or to accurately place the position of the display element corresponding to the event, on the map of the user interface. Contextual information can be any type of information relating to the navigable route, including previous maneuvers, upcoming maneuvers, the speed, direction, and/or location of a user computing device, and so on.

Other implementations of these and other aspects include corresponding computer systems, apparatuses, computer-readable storage media, and computer program products recorded on one or more computer storage devices, each configured to perform the actions of the methods.

### BRIEF DESCRIPTION OF THE DRAWINGS

FIG. 1 is a block diagram illustrating the generation of an event summary using a verbal description and contextual information as input to a real time event tracking system, according to aspects of the disclosure.

FIG. 2 illustrates an example view of the user interface displaying an event summary along a navigable route, according to aspects of the disclosure.

FIG. 3 is a block diagram of the example real time event tracking system of FIG. 1.

FIG. 4 illustrates a view of the user interface displaying a report event element and other specific report event elements, according to aspects of the disclosure.

FIG. 5 illustrates a view of the user interface displaying multiple event summaries with varying degrees of labeled severity, according to aspects of the disclosure.

FIG. 6 is a flow diagram of an example process for generating real time event summaries, according to aspects of the disclosure.

FIG. 7 is a block diagram of an example computing environment for implementing the example real time event tracking system, according to aspects of the disclosure.

### DETAILED DESCRIPTION

### Overview

Aspects of the disclosure are directed to a real time event tracking system for generating and providing summaries of events reported by users along navigable routes in real time. An example real time event can be a traffic event that is observed by a user navigating along a route provided by a navigation system. The tracking system can receive verbal descriptions of events encountered by a user, for example while operating a vehicle. The verbal description can be a remark or description of the event, provided through voice input to a computing device implementing a navigation system, such as a smartphone, tablet, or the vehicle itself. A navigation system can provide instructions including directions for traveling from a starting point to an ending point, the route traveled referred to as a navigable route in this specification. Given that user input may be received while a user is operating a vehicle or is otherwise preoccupied, the tracking system as described herein avoids complicated, clumsy and/or and information-dense user interfaces with interactable elements for various event types, which may be slow or hazardous to interact with and use to report an event in real time. User interfaces with multiple interactable elements may require a display to scroll or pack elements into multiple sub-menus, drop-down menus, or windows, all which requires more power to render and display as the screen is updated in response to user navigation input.

Contextual information can be received alongside a verbal description and can be used to improve the accuracy or clarity of the output of the tracking system, for example to improve event classification, spam identification, summarization of a reported real time event, or accurately positioning a display graphical element for an event summary at a position on a map displayed by a user interface, e.g., for a navigation system. Contextual information can be used for augmenting or improving the accuracy of summaries generated using verbal description alone, for example by adding more specificity as to the nature of the described event when summarized and displayed on the user interface. Contextual information can be any type of information relating to the navigable route, including previous maneuvers, upcoming maneuvers, speed, direction, location, and so on. In some examples, the system can obtain contextual information relating to the navigable route from the verbal description itself.

For example, a verbal description may indicate that “that was a tough turn,” in response to previous maneuver taken by a vehicle along a navigable route. The tracking system can process both the verbal description and the previous maneuver, e.g., an instruction indicating “a right turn 50 meters ago,” to summarize the real time event as a “difficult right turn.” To that end, the tracking system can incorporate contextual information when available, determine its relevance to generate or augment the resulting summary. To reduce or eliminate the processing of user input that is not indicative of a real time event, the tracking system can include an AI model trained for spam classification. The AI model processes potentially irrelevant user input without placing the burden on the user to provide only relevant input, which may also reduce the effectiveness of the user interface by inundating it with additional elements or prompts for additional user input before event publication. Spam or irrelevant input can be discarded, improving resource utilization overall by only processing verbal descriptions predicted to relate to a real time event.

The verbal description and contextual information can be used for improving real time reporting accuracy. Because a user computing device may be enroute to a destination, the computing device may continue to move while input is received for reporting an event. For example, if the verbal description received is “speed trap camera two blocks ahead,” then the AI model(s) trained to receive and process the verbal description as described herein can determine the relative positioning of the event (e.g., the presence of a speed trap) based on the description of the speed trap camera ahead of the location of the user computing device when the verbal description was received.

Adding contextual information, such as a previous maneuver, can improve the position on a map to which an event summary is published. For example, if a verbal description is received with contextual information in the form of a previous maneuver indicating “right turn 200 meters ago,” then the position of the graphical display element for the resulting event summary can be offset 200 meters relative to the device's current location.

A large language model or other artificial intelligence (AI) model configured to receive text input can be trained or fine-tuned to perform aspects of the technology. The AI model can be composed of one or more different models trained to perform various operations described herein, including spam identification, event classification (e.g., with or without contextual information), summarization, and data generation. The tracking system can generate a prompt at least partially written in natural language, which includes a text version of an input verbal description, as well as any available contextual information. The prompt can also include classifications of the described real time event, generated by one or more AI models configured to receive the verbal description and contextual information.

The same or different AI model can be trained or fine-tuned to classify the real time event using the prompt as input. The model output can be a summary of the real time event, following a predetermined format to allow for succinct but informative information to be displayed or output by a user computing device. For example, the predetermined format can set a character limit to the summary, e.g., 20 characters. The character limit can be set, for example, based on what the user interface is configured to output in accordance with a predetermined font size, without causing the summary to scroll or otherwise be partially cut off when displayed through the user interface.

On the user interface, the generated summary can be associated with a graphical display element, which can include an icon generated or selected from a list of predetermined icons by the same or different AI model. The generation or selection can be based on a predicted relevance output by the model between the generated summary and the corresponding graphical display element. The graphical display element can be displayed on a map through the user interface for indicating the location of the real time event.

New event summaries can be published and made accessible for display or output by other user computing devices implementing the same navigation system. More specific and accurate summaries can be published, as users can send reports with less interaction with a user interface, versus approaches in which there may be scrolling or multiple sub-menus to navigate to find the element for reporting a specific type of event. The accessibility of the interface can encourage more prompt updating, at least because the number of interactions with the interface can be reduced overall. In some examples, the tracking system can prompt for user confirmation that the generated event summary is accurate, before publishing. The tracking system can publish the event summary, which may be displayed or output by other user computing devices. Those user computing devices can receive user input for confirming the accuracy of the event, as well as receive additional verbal descriptions for describing the same event or a different event.

The prompt can also include an indication of whether the verbal description is categorized as spam or irrelevant, which can be generated by the same or a different AI model. The AI model can be trained or fine-tuned to determine whether certain verbal descriptions are not indicative of real time events, but are instead general observations by a user, background noise, or speech that is not directed to the computing device in receipt of the verbal description for purposes of reporting a real time event. Rather than fully process prompts categorized as spam, the system can terminate processing with a predetermined response, e.g., to inform a user that the received input was not understood or not interpreted as relating to an event for reporting.

Aspects of the technology provide for at least the following technical advantages. More real time events can be reported and summarized without adding a corresponding user-interactable element for each event type on a user interface of a computing device. The system can receive, filter, and process incoming verbal descriptions for classifying and generating summaries with custom graphical display elements. The system reduces or eliminates the need for manual click or touch input to a user interface, by using verbal descriptions as user input, which can be provided in a hands-free manner. In examples in which user attentiveness to operating a vehicle or other device is important, the system reduces the need for user-interactable elements for reporting specific types of events, which opens the interface up to larger user-interactable elements in general. User accessibility is improved with larger user-interactable elements and/or fewer elements in general on a user interface, particularly for devices with small screens, such as smartphones.

Power consumption on a user device can be reduced, at least because fewer interactions and elements for reporting events reduces the frequency at which a user interface is updated for display. For example, with fewer user-interactable elements overall, more of an interface can be displayed without needing to scroll or through sub-menus or additional windows. Especially on devices with smaller screens which are also often resource-constrained, e.g., battery-powered mobile phones, reducing how often the user interface has to be refreshed to display new elements can reduce power consumption overall.

Events can be reported faster, making the resulting map for a navigation application more accurate to users of the application. For example, aspects of the disclosure provide for reducing the amount of user interaction to a verbal description, and augmenting that verbal description with contextual information provided by the user device. Reduced user interaction reduces the latency between user input and updating a map with a summary of a reported event. Other user devices retrieving data from a server maintaining the map can retrieve maps that are more up-to-date, as a result of this reduced latency. The reduced user interaction required can also encourage more reporting overall, as users are more likely to provide reports as aspects of the disclosure provide for doing so without the clumsy, challenging, and often unsafe approaches requiring specific user-interactable elements on a display.

Given the volume of different real time events that may be encountered, aspects of the technology bypass the need to predetermine which real time event types warrant a corresponding user-interactable element, by enabling verbal reporting for many more event types than may be displayed or output on a user interface. The overall functionality of the reporting system is improved relative to approaches that limit reports to event types represented by separate user interface elements. This is at least because the user interface as described herein allows for easier and safer user interaction during vehicle operation, while not limiting the types of reportable events to what is shown on the user interface.

By incorporating contextual information, such as previous or upcoming maneuvers along the navigable route taken by a vehicle, the user interface can be further simplified, by not requiring as detailed verbal description and eliminating or reducing the need for additional prompts to the user for more information.

### Example Systems

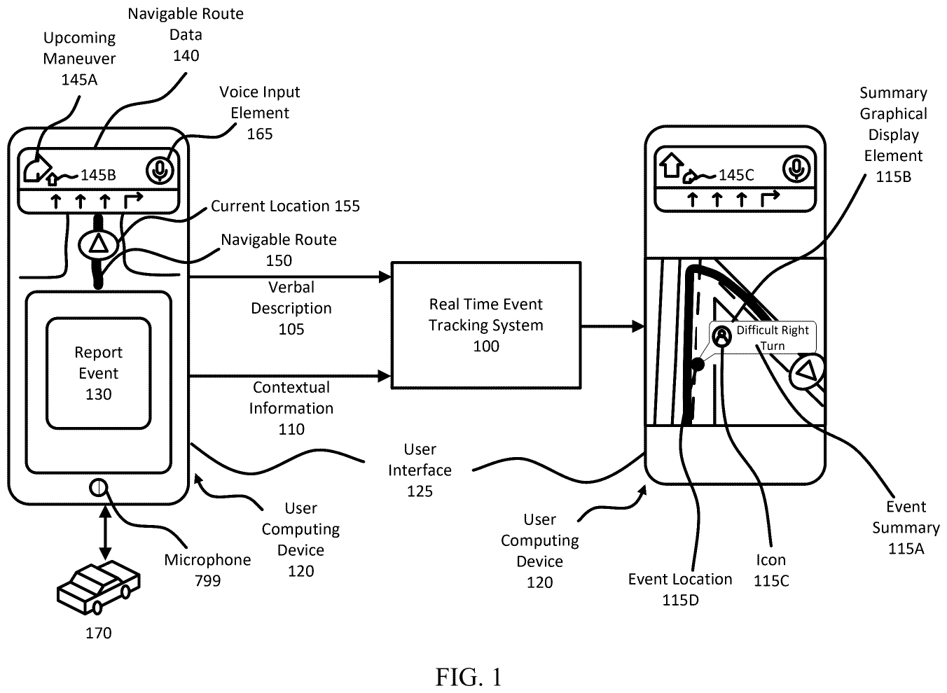

FIG. 1 is a block diagram illustrating the generation of an event summary 115A using a verbal description 105 and contextual information 110 as input to a real time event tracking system 100, according to aspects of the disclosure. User computing device 120 receives a verbal description 105 of an event encountered along navigable route 150 and processes the description and any available contextual information 110 through the system 100 to generate the event summary 115A. Event summary 115A can be displayed as a short summary with a summary graphical display element 115B and/or an icon 115C on a display of the user computing device 120.

The user computing device 120 can be, for example, a personal computer, a laptop, a smartphone, a tablet, a wearable device, and so on. The user computing device 120 can be a manually or autonomously operated vehicle, e.g., vehicle 170, which can be a bicycle, motorcycle, automobile, boat, and so on. User computing device 120 can be integrated or connected with the vehicle 170, e.g., through a cable, or integrated as part of a console or other component of the vehicle 170. In some examples, the user computing device 120 is not operated in or around a vehicle.

A real time event can refer to the occurrence of an event of something while operating the user computing device 120. A real time event may be on-going, or have already occurred, for example, within seconds or minutes of when the event was observed. Examples of real time events can be traffic congestion, the presence of animals or children on a roadway, a parade, and so on. These and other traffic events are examples of real time events for which the system 100 receives a verbal description 105. Although examples provided herein focus on traffic events, any occurrence or observation of something encountered by a user operating the user computing device 120 can be a real time event. In some examples, real time events need not be observed by a user, but instead be sensed by sensors such as cameras, microphones, and so on, which can be connected to appropriately configured software or hardware for generating a description of the event as input to the system 100. In those examples, the verbal description 105 may be text or sensor data, which the tracking system 100 can also be configured to process as input.

The system 100 is configured to generate summaries and display elements on the user interface 110 in real time, relative to receiving the verbal description 105. The system 100 can automatically display graphical elements, icons, and/or summaries in response to receiving audio input including the verbal description 105. For example, the system 100 can output display graphical 115B, icon 115C, and/or summary 115A in seconds or minutes from receiving verbal description 105 and contextual information 110.

The verbal description 105 can be a remark or description of the event, provided through voice input to the user computing device 120. The user computing device 120 can implement a microphone, such as microphone 799, for receiving audio. The verbal description 105 can be provided by a user of the user computing device 120.

In FIG. 1, the user computing device 120 is shown as displaying a user interface 125. User interface 125 can be configured to display or output information, as well as to receive information according to different modalities. For example, the user interface 125 can include a touch-screen display on the user computing device 120, configured to reach touch, tap, or other physical inputs for interacting with displayed user-interactable elements. The user interface 125 can also include software for causing various elements of the interface 125 to output or display information, as well as accept input. User-interactable elements can include buttons, toggles, input fields, dropdowns, checkboxes, sliders, input steppers, and so on. Report event element 130 is an example of a user-interactable element, shown as a button configured to receive touch input through the display of the user computing device 120.

User interface 125 can be configured to receive voice input, for example through the interaction of report event element 130. The report event element 130 can be a touch or tap-interactive element on the user interface 125, which can be sized larger relative to other elements, so as to make the element a larger target for user interaction. As another example, the user computing device 120 can detect the utterance of a hotword, indicated by voice input element 165. A hotword can be one or more words. An example hotword can be “hey computer,” which the user computing device 120 is configured to detect for beginning to receive speech input following the hotword. An example verbal description can be “this is a difficult turn,” for example in response to a difficult turn that was executed as navigating the user computing device 120 along the navigable route 150.

The user computing device 120 can be configured to determine and display navigable routes for reaching a destination. A navigable route includes instructions for reaching a destination, which can include directions, maneuvers, distances, street names, and other indicators for assisting in the navigation of the user computing device 120 to the intended destination.

Navigable route data 140 can include any data related to the instructions of the navigable route, such as upcoming maneuver 145A, previous maneuver 145B, and current location 155. Maneuvers can be displayed or output by the user interface 125, for example as written or spoken instructions. An example previous maneuver 145B can be “bear straight 50 meters ago.” An example of an upcoming maneuver 145A can be “right turn in 20 meters.” Distances indicated in the maneuvers can be tracked and updated by the system 100, for example to remain relative to a current position of the user computing device 120.

Navigable route data 140 can be displayed or output through the user interface 125 in different ways. In addition to displaying elements of the user interface 125 corresponding to, for example, the upcoming maneuver 145A, the previous maneuver 145B, the user interface 125 can also audibly output upcoming maneuvers or other information about the navigable route 150. Other information that can be output about the navigable route 150 includes event summaries from previously reported events.

Contextual information 110 can be any type of information relating to the navigable route, including navigable route data 140, such as previous maneuvers, upcoming maneuvers, speed of the user computing device, the direction the user computing device 120 is facing, the current location 155 of the user computing device 120, and so on. Although examples provided are also shown in the user interface 125, e.g., as maneuvers 145A-C, contextual information 110 need not be also displayed or output through the user interface 125 to be used as input by the system 100. Contextual information 110 can be stored as text, numbers, and/or other formats as metadata maintained by one or more devices implementing the system 100.

As another example, the verbal description 105 and contextual information 110 can be provided after the observation of the real time event. For example, instead of the verbal description 105 being “this is a difficult turn” and the contextual information 110 including an upcoming maneuver 145A specifying a right turn, the verbal description 105 can be “this was a difficult turn” and the contextual information 110 can include a previous maneuver 145C indicating a previous right turn. The system 100 can place a generated summary and summary graphical display element 115B somewhere earlier in the route 150, e.g., before the subject right turn. In general, the system 100 can publish events reported before, during, or after the occurrence of the event in question.

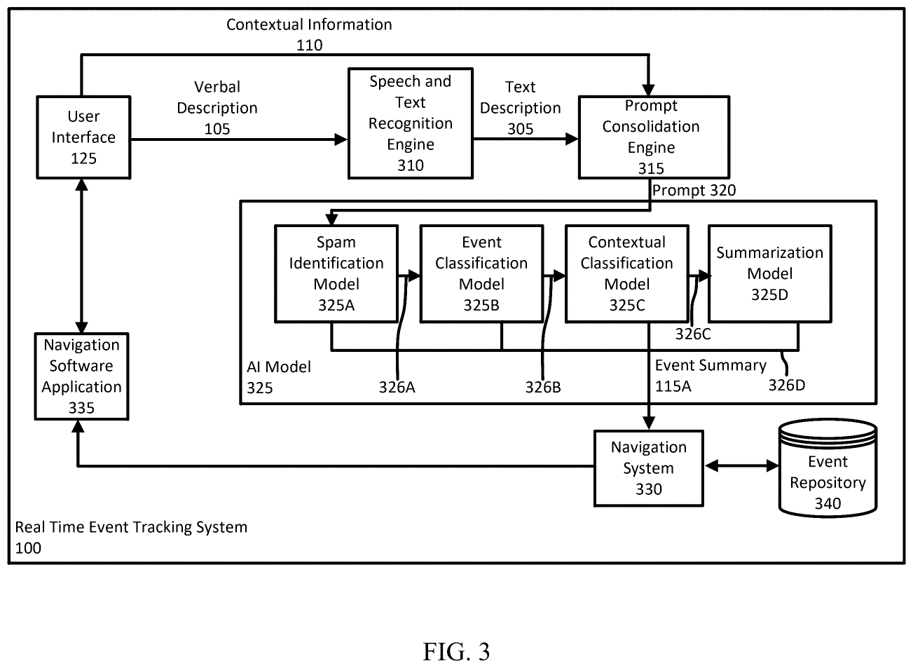

The system 100 generates an event summary 115A, for example through a processing pipeline described in more detail with reference to FIG. 3. The event summary 115A can incorporate contextual information 110 to add more detail to the summary than what can be provided by the verbal description 105. For example, the event summary 115A generated can be “difficult right turn,” summarizing the verbal description of “that's a difficult turn,” with contextual information 110 including a right turn as the upcoming maneuver 145A and/or the previous maneuver 145C, depending on the current location 155. The system 100 is configured to generate short summaries, e.g., no more than 20 characters, so as to be displayed through the user interface 125 without requiring text scrolling or changing the current view of the navigable route 150 on the user interface 125 to fit the summary on-screen. The character limit can vary from example-to-example, but is generally capped, for example based on an empirically determined amount as to how much text the average user can read at a glance, avoid or reduce distraction, and/or to avoid or reduce obstruction of other elements on the user interface 125.

Prior to publishing the event summary 115A, e.g., providing the event summary 115A for display or output on the user interface 125, the system 100 can output a request for user confirmation of the summary through the user interface 125. The system can receive a response, for example as a speech input or input through a corresponding element (not shown) on the user interface 125. For example, the system may output, as a request, “do you want to publish ‘<(caution) difficult right turn>’ to the map?” In response to a positive indication, the system 100 can publish the summary to appear on the user interface 125, for example as shown in FIG. 1, and on other user computing devices coupled to system 100. In response to a negative indication, the system 100 can discard the event summary 115A. The system 100 can proceed to receive input for editing or generating a new event summary or abandon event reporting for the given report altogether.

The system 100 can generate or select a corresponding icon 115C or other part of the summary graphical display element 115B based on the event type of the reported event. Summary graphical display element 115B can refer to an element for graphically presenting the summary 115A. For example, the graphical display element 115B can refer to the font of the summary 115A as shown on the user interface 125 as well as other fonts, colors, shapes, sizes, images, and/or other visual elements, such as a speech bubble pointing to an event location 115D. Event location 115D refers to the location at which the real time event occurred, which can be determined based on system output, e.g., output from an AI model of the system 100.

The icon 115C may be any shape, image, and/or visual element, of any color, size, shape, and so on. The system 100 is configured to generate or select an icon 115C based on the generated event summary 115A. For example, different classes of real time events and/or different summaries generated for those events may have different icons associated with those classes or summaries. For example, one icon may be associated with road hazard events, another icon for people or animals along the route, and so on. The system 100 can generate icons, for example in cases in which a particular icon is not already available for a specific summary or event type.

The summary graphical display element 115B and/or icon 115C can improve the accessibility of the user interface 125, for example by associating different related event types together, such as difficult maneuvers to execute while navigating along the route 150. Other example summaries can be: “celebrations around,” “hectic traffic today,” “animals on road,” “very narrow road,” “poor turn visibility,” “no turn 9 AM-10 AM,” “rough speed bumps,” “children on road,” “difficult right turn.” These and other event types may have different icons generated by the system 100, as described herein.

As an example, the system 100 may display icons with similar visual elements, but specific to different events summarized within an event type. For example, if the real time event is summarized as a “duck crossing,” the system can generate an icon portraying a duck or similar animal, in the style of other icons associated with events of animals on the road. The similar style may be, a similar art style and/or a similar or same color, outline shape, etc.

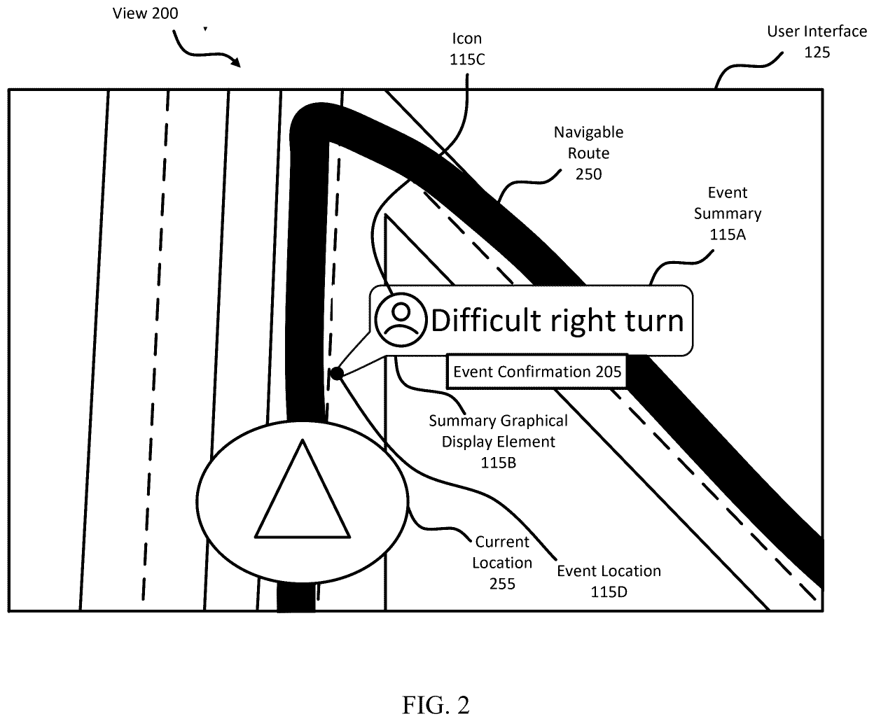

FIG. 2 illustrates an example view 200 of the example user interface 125 displaying an event summary 115A and graphical display element 115B along a navigable route 250, according to aspects of the disclosure. In some examples, user interface 125 may be implemented as part of a computing device different from user computing device 120. The navigable route 250 can be displayed on the same or different user computing device as the device 120 and can be different from the route 150 shown and described with reference to FIG. 1. User interface 125 can retrieve and display event summary 115A and display element 115B, for example based on the event being reported in the same location as near current location 255 of a user computing device in navigation. The user interface 125 can include an event confirmation element 205, configured to receive user input for confirming or agreeing with the accuracy of the event summary 115A.

For example, the user interface 125 can prompt for user input, and if the user input positively indicates the accuracy of the event summary 115A, the system 100 will continue to publish the event summary 115A to other user computing devices navigating along routes near the occurrence of the corresponding event. As another example, if the user interface 125 receives user input indicating that the event summary 115A is not accurate, the system can remove the event summary 115A from further publication, or at least from further publication to the user computing device corresponding to the user interface 125.

In some examples, the determination by the system 100 to persist or remove publication of an event summary can be based on meeting a predetermined threshold of user inputs from different devices in communication with the system 100, either with positive or negative indications. In some examples, the prompt for confirmation can be audible, for example through speakers of a computing device, and triggered in response to the navigating user computing device arriving near the location of the reported event. In some examples, the event confirmation element 205 can be transient, appearing only momentarily but disappearing if no input is received, for example physically or audibly, by the user computing device implementing the user interface 125.

In some examples, the event summary 115A can be an annotation, revision, or replacement to a previously-generated summary. For example, the real time event may change over time, which can be reflected in summaries that replace previously-generated summaries.

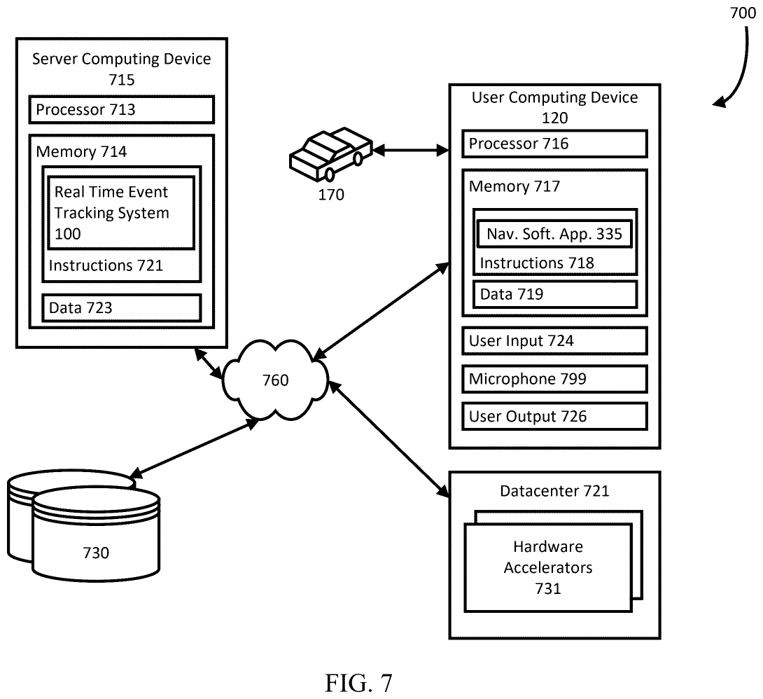

FIG. 3 is a block diagram of the example real time event tracking system 100 of FIG. 1. The system 100 can be implemented on one or more computing devices in one or more locations. For example, the system 100 can be implemented entirely on a user computing device, such as the user computing device 120 of FIG. 1. As another example, the system 100 can be performed between servers and user computing devices, examples of which are discussed at least with reference to FIG. 7.

The system 100 receives a verbal description of a traffic event through the user interface 125. The description can be speech received by a microphone coupled to a user computing device. An example verbal description can be “That turn was impossible, I waited 10 minutes.” Speech and text recognition engine 310 is configured to convert the received verbal description into a text description 305. The engine 310 can implement any technique for speech to text translation, for example using a machine learning model trained according to any known natural language processing technique for converting audio input into corresponding text.

Prompt consolidation engine 315 is configured to receive contextual information 110. Example contextual information include previous maneuvers 145B and upcoming maneuvers 145A, or any other information as described herein. The system 100 can implement a navigation system 330 and navigation software application 335. The navigation system 330 can be configured to generate instructions for navigable routes from a starting location to an ending point. The navigation system 330 can be in communication with a GPS or other location tracking technology, as well as implement path-finding techniques for generating instructions for navigable routes to an ending point. Input and output can be processed through a navigation software application 335, for example implemented on user computing device 120.

In some examples, the prompt consolidation engine 315 can generate multi-modal prompts, e.g., including a combination of text, audio, video, or images. For example, instead of generating text description 305, the prompt consolidate engine 315 can generate a prompt that includes an audio recording of the verbal description 105. In these examples, the AI model 325 is trained to receive and process multi-modal prompts, for example a prompt including the verbal description 105. For example, the AI model 325 can be trained to directly process verbal descriptions as audio input, or perform an internal speech-to-text conversion as part of a model pipeline.

The contextual information can be of one or more modalities, e.g., a combination of textual data, image data, audio data, video data, and so on. In some examples, the prompt consolidation engine 315 can receive a screenshot of the user interface 125, including navigable route 150 and any graphical display elements currently in view on the user interface 125. The generated prompt 320 can include the screen shot, which can be provided as input to the AI model 325 for processing. The AI model 325 can be trained to identify contextual information provided through the screen shot, for example event summaries at locations outside of the locations through which the navigable route 150 goes through. For example, event summaries reporting “parade route through here” can be identified by the AI model 325, e.g., using image processing techniques such as segmentation, and accumulated as contextual information. Continuing the example, the added contextual information may help increase the probability that the AI model 325 predicts an event type of a reported real time event as also part of a parade route.

As another example, if the verbal description 105 is “there is a traffic jam on the street to my left,” the contextual information 110 can include a screenshot of the user interface 125 with graphical display elements indicating levels of congestion on nearby roads. The indicators can be different-colored roads depending on the level of reported congestion. Based on the contextual information provided on nearby roads, the system 100 can generate summaries referring to increased levels of congestion. For example, the system 100 may output an event summary indicating “traffic building up” along the navigable route 250, given traffic build up on roads near the route but that are not part of the navigable route 250 itself.

The navigation system 330 can receive a request for generating instructions for a navigable route, which can rely on map information and information about different routes that are available between different geographical locations. The system 330 can determine a route from a starting position to an ending point, for example as a composite of predetermined routes to and from geographical locations between the starting point and ending point. The starting point and ending points can be determined, for example, based on the current position of the user computing device 120, predetermined points-of-interest (POIs), and/or through user input. The navigation system 330 and/or the navigation software application 335 can be configured to receive or determine mapping information, route information, and/or information related to POIs proximate to the location of the user computing device 120 or other device implementing the system 330 and/or software application 335.

In some examples, route instruction generation is performed entirely by the navigation system 330, implemented on one or more server devices communicatively coupled to a user computing device implementing the software application 335. In some examples, the software application 335 is a frontend application for communicating input and output through user interface 125.

Prompt consolidation engine 315 generates a prompt 320 for input to artificial intelligence (AI) model 325, using at least text description 305 and contextual information 110, if available. The prompt 320 can follow a predetermined format, e.g., the same format the AI model 325 is configured to receive as input. For example, the prompt can be formatted according to JSON or another file format. An example formatted prompt generated by the engine 315 can be: {“description”: “That turn was impossible, I waited 10 minutes”, “previous_maneuver”: “Turn right onto Main Street, 10 seconds ago”, “next_maneuver”: “In 200 meters go straight.”}. “description”, “previous_maneuver”, “next_maneuver” are fields in the prompt, with values that can correspond to the text description 305, previous maneuver 145B, and upcoming maneuver 145A, respectively.

The prompt consolidation engine 315 can include instructions in the prompt 320 for the AI model 325 to use to generate output and/or to describe the input. For example, the prompt 320 can include a description of different fields, e.g., a description of what a “description” field, and so on. Example descriptions include “the ‘previous_maneuver’ field describes what the last maneuver was performed along the navigable route,” “the description field includes a user-provided description of a real time event,” and “the ‘upcoming_maneuver’ describes what the next maneuver to perform along the navigable route is.”

The prompt consolidation engine 315 can include further instructions to the AI model 325 for how to format output, e.g., as described above with reference to a predetermined format. The prompt consolidation engine 315 can include instructions for incorporating some or all of the fields of the input, for example based on whether the AI model 325 determines the fields to be relevant for generating the output event summary 115A. The prompt consolidation engine 315 can include instructions for specifying the format of event summaries, to generate icons or select icons from event repository 340, and to determine a severity of the event, e.g., “low,” “medium,”or “high”priority.

AI model 325 is shown as including multiple models 325A-325D, but in some examples the AI model 325 is trained to generate some or all the outputs 326A-326D described herein. In some examples, the AI model 325 is a single model.

An architecture of a model can refer to characteristics defining the model, such as characteristics of layers for the model, how the layers process input, or how the layers interact with one another. For example, the model can be a convolutional neural network that includes a convolution layer that receives input data, followed by a pooling layer, followed by a fully connected layer that generates a result. The architecture of the model can also define types of operations performed within each layer. For example, the architecture of a convolutional neural network may define that rectified linear unit (ReLU) activation functions are used in the fully connected layer of the network. The AI models 325, 325A-325D can be implemented according to various different architectures, such as generative models, including language models, foundation models, diffusion models, and/or graphical models. One or more model architectures can be generated that can output results associated with real time event reporting, including spam detection, event classification, and/or summarization, as described herein.

As another example, AI model 325 can be implemented as a large language model fine-tuned or prompted to generate the model outputs described herein. For example, the large language model can be trained to receive input as a number of tokens generated from an input prompt. The prompt can be text, video, audio, images, computer code, or a combination of the preceding. The AI model 325 can be built using transformers, e.g., transformers with multi-headed attention mechanisms, and/or a combination of models, such as using a mixture-of-experts (MoE) approach. Tokens can represent portions of text, video, audio, images, etc., which the AI model 325 can process to recognize patterns in the input and generate output in accordance with those patterns.

The machine learning models can be trained according to a variety of different learning techniques. Learning techniques for training the machine learning models can include supervised learning, unsupervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, a supervised learning technique can be applied to calculate an error between outputs, with a ground-truth label of a training example processed by the model.

Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights and/or other model parameters for the model can be updated.

The model can be modified or updated until stopping criteria are met, such as a number of iterations for training, a maximum period of time, a convergence of estimated rewards or value between actions, or when a minimum value threshold is met. A model can be a composite of multiple models or components of a processing or training pipeline. In some examples, the models or components are trained separately, while in other examples, the models or components are trained end-to-end.

The AI model 325 may be trained using a foundation model or other model pre-trained to generate encoded representations of different tokens or input to the model 325. A pre-trained model can be further trained or fine-tuned with additional prompts labeled with a target output for the model 325 when processing the prompts as input. Fine-tuning a model can include performing one or more iterations of training, e.g., a forward pass, backpropagation, weight update, on a smaller dataset than what was originally used to train the model. The smaller dataset is often more specialized than the initial data set used for training and is reflective of specific inputs and outputs the model is being trained to process and generate. The target output can also be pre-formatted according to a desired format for the model output, for example in a mark-up language, JSON, and so on. The AI model 325 may associate input with a context window, which can be a length of token the AI model 325 can receive as input for generating an output at once. The AI model 325 can be trained or based on a model that was trained using reinforcement learning from human feedback (RLHF) or other feedback from other techniques for ranking model output and determining a rewards model for rewarding the AI model 325 to generate outputs aligning with the feedback.

Large language models or other types of machine learning models configured to receive prompts can improve the overall flexibility of the system 100 in generating summaries of reports of different types. Pre-trained models can be leveraged for their inherent language understanding functionality, allowing for different types of events to be processed and thereby reducing the number of specialized components needed for generating event summaries. Further, the number of user-interactable elements on the user interface 125 can be reduced, at least because fewer specialized components or pipelines are needed, thereby requiring fewer user-interactable elements overall.

Spam identification model 325A is trained to the text description 305 in the prompt 320 as either spam or not, indicated by model output 326A. Spam can include information that is predicted to not be related to a real time event. For example, if the received description is “there is a nice car parked here,” The spam identification model 325A can classify that as spam for not relating to a traffic event. What is considered spam or not depends on the nature of real time events that are being tracked. Following a classification of spam, the system 100 can output or display a response through the user interface 125 indicating that the input description was not considered for generating an event summary. For example, the output can be “that doesn't sound like a traffic report, but thanks for letting me know!” In examples in which the prompt 320 to the AI model 325 includes a “spam” field indicating the presence of spam, the AI model 325 can cease processing the prompt 320.

Spam can be determined by the spam identification model 325A using prompt instructions in the prompt 325 and/or through supervised training using examples of input that are indicative of spam. For example, the model 325A can be fine-tuned through one or more examples of verbal descriptions and contextual information with a label indicating that the description is spam for not describing a real time event along a navigable route.

Prompt instructions can include instructions to check for logical consistencies between contextual information and verbal descriptions, with inconsistencies indicating spam. For example, the spam identification model 325A can receive contextual information to further identify the presence of spam in a verbal description. For example, if the contextual information is an upcoming maneuver is to stay along a straight road ahead, but the verbal description is “that's an illegal right turn!”, the model 325A can predict the verbal description is spam, through an inconsistency between the verbal description and the contextual information. Prompt consolidation engine 315 can include instructions in the prompt 320 for instructing the spam identification model 325A on determining spam in the context of received input. Model output 326A can correspond to the classification of the model 325A of spam.

Event classification model 325B is trained to generate a classification of the type of event described by the text description 305. The event classification model 325B can be trained or fine-tuned in accordance with a multi-class classification problem, in which the model outputs probabilities that the input text description 305 corresponds to different predetermined event types. Model output 326B can be the event type with the highest predicted probability.

In general, the number of potential event types used to train the event classification model 325B can range from tens to hundreds of types, in excess of what can be represented on the user interface 125 without very small elements or more scrolling than can be done, for example at a glance, while a user is operating a vehicle. The event classification task the model 325B is being trained to perform can be presented as a multi-class classification problem, in which the model 325B is trained to generate probabilities that a given input corresponds to different predetermined classes. In some examples, the model 325B can be trained to cluster similar input, e.g., to associate various inputs as corresponding to similar events, even if a specific label for the cluster of events is not available initially. A separate process can be performed, e.g., the AI model 325 or another component downstream of the model 325B, to determine labels for each cluster identified by the model 325B.

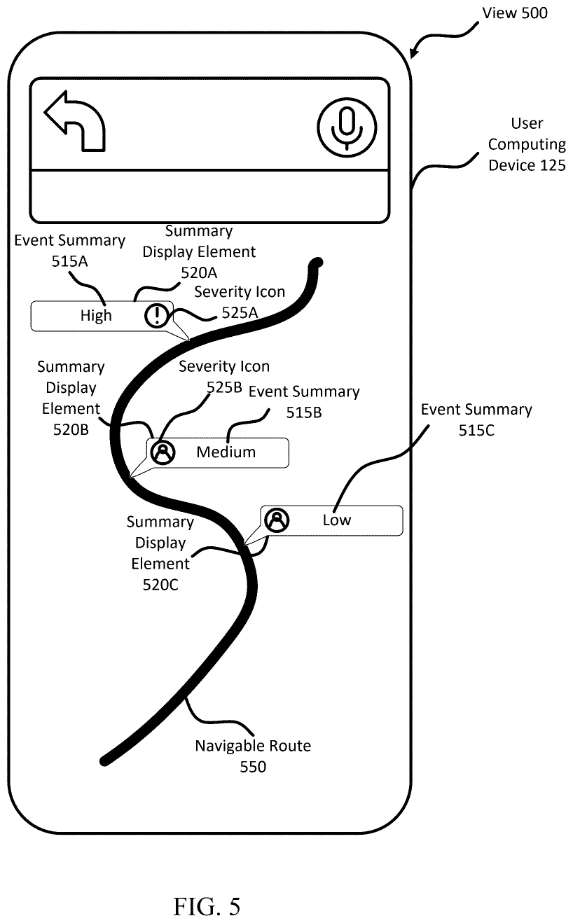

In some examples, the event classification model 325B can be trained to output classification severities for each event. Example classes of severity can be “high,” “medium,” or “low”. Based on the traffic event type, the AI model can also output a recommended severity classification and user interface icon corresponding to the traffic event type. In the example above about the reported difficult turn, the AI model can output a “difficult turn” event type, with a “caution” icon and “moderate” severity. FIG. 5 illustrates an example view of user interface 525 with event summaries of varying degrees of severity. Examples can be provided as part of fine-tuning the model 325B to attach a severity class to each input. The system 100 can provide the severity class as part of a corresponding graphical display element for an event summary, and/or perform different processes depending on the severity class. For example, events reported with higher predicted severities may be flagged by the system 100 for further inspection and review.

Contextual classification model 325C can further classify the event type predicted by the event classification model 325B based on relevant contextual information, generating a classification as model output 326C. From the contextual information, the AI model can further specify the type of turn taken. For example, if the contextual information included a previous maneuver of “left turn 50 meters ago,” the contextual classification model 325C can output a more specific “difficult left turn” event type, even if the user input description did not specify the direction of the turn. As another example, if the description is “the upcoming turn is difficult to take with the oncoming traffic,” the contextual classification model 325C can also process the upcoming maneuver in the contextual information and output an event type of “difficult right turn.”

In some examples, only one of the contextual classification model and the event classification model 325B is used to process the prompt 320, for example based on the absence or presence of contextual information. Model output 326B can be the event type for the prompt 320 with the highest probability, according to model 325C. In some examples, the contextual classification model 325C generates an event type without receiving model output 326B.

The summarization model 325D is trained to generate event summary 115A of the input verbal description 105 and contextual information 110. The summarization model 325D can further receive, as input, model outputs 326A, 326B, and 326C. The summarization model 325D can generate an output 326D summarizing the verbal description and the contextual information in accordance with previously received fine-tuning examples, and/or prompt instructions in the prompt generated by the prompt consolidation engine 315. In some examples, the event summary 115A can be or include the classifications generated as model output 326B or model output 326C, e.g., “difficult right turn,”as in the example above.

The model output 326D can follow a predetermined format to allow for succinct but informative information to be displayed or output by user interface 125. For example, the predetermined format can set a character limit to the summary, e.g., 20 characters. The character limit can be set, for example, based on what the user interface 125 is configured to output in accordance with a predetermined font size, without causing the summary to scroll or otherwise be partially cut off when displayed through the user interface 125.

The system 100 can format the event summary 115A. An example event summary 115A is: summary {“summary”: “Difficult right turn”, “additional”: “Onto Main Street”, “severity”: “medium”, “spam”: false}. In this example, “summary” is the field whose value is used by navigation system 330 and navigation software application 335 to display event summary 115A through user interface 125. The number and naming of the fields of the event summary 115A can vary from example-to-example, for example to not include a severity classification, not include a spam classification, and so on.

The summarization model 325D can generate an icon corresponding to the event summary 115A. The icon can be provided as part of the graphical display element of the summary, when the summary is published to the user interface of a computing device. Summarization model 325D can be a text-to-image model, for example implemented as a diffusion model or other model trained to generate images from text prompts, for generating images based on prompts. The prompt can include event summary 115A. For example, if the real time event is summarized as a “duck crossing,” the system can generate an icon portraying a duck or similar animal, in the style of other icons associated with events of animals on the road. The similar style may be, a similar art style and/or a similar or same color, outline shape, etc. The system 100 can store generated icons in event repository 340, which can include a database for searching for previously-generated icons. Generating icons based on event summaries enables the system 100 to publish summaries for different events that have not been previously reported.

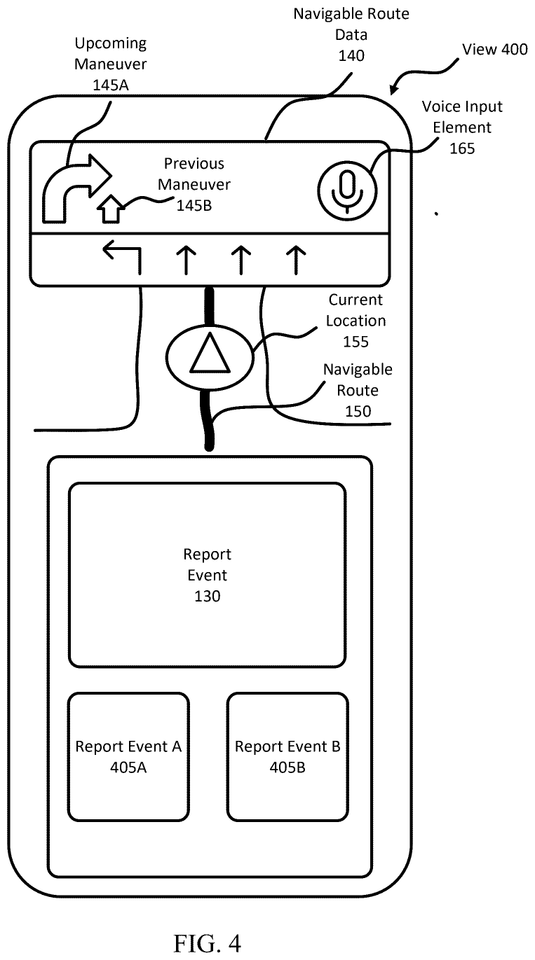

FIG. 4 illustrates an example view 400 of the user interface 125 displaying report event element 130 and other specific report event elements 405A and 405B, according to aspects of the disclosure. Elements 405A and 405B can be configured to receive input to report events of specific types “A” and “B”, respectively. The number of elements 405A-405B can vary from example-to-example, but elements 405A-405B are generally not exhaustive in covering all types of possible events that may occur along the route 150. A specific type may be “traffic accidents,” or other types of events predetermined, for example, based on predicted severity of events of this type, or frequency at which these events are reported.

Although the drawings herein are not to scale, the report event element 130 can be placed more prominently relative to other interactable elements, so as to make user interaction with the interface through physical contact easier. Screen space can be saved overall by aspects of the disclosure allowing for any number of event types to be reported from the same user-interactable element, which can be especially beneficial for smaller screens, such as on smartphones or tablets.

FIG. 5 illustrates an example view 500 of the user interface 125 displaying multiple event summaries 515A-515C with varying degrees of severity, according to aspects of the disclosure. Event summaries 515A-515C are displayed along navigable route 550. Event summary 515A is marked with “High” severity icon 521A. event summary 515B is marked with “Medium” severity, and event summary 515C is marked with severity “Low,” and severity icons 525B and 525C, respectively. The event summaries 515A, 515B, 515C are shown with “High,” “Medium,” and “Low,” respectively, for clarity, but it is understood that the summaries can include text summarizing various events that have been categorized as high, medium, or low severity. Icon graphics may be shared between summaries of varying degrees of severity, and can vary also in color, boldness, shape, size, and so on. Event severity can be indicated through text, the icons 525A-525C, or a combination of text and icons. Summary graphical display elements 520A-520C and icons 525A-525C can vary, for example based on the severity classification, e.g., to emphasize events of higher or lower severity.

As described above, the model 325 can be fine-tuned with training examples to determine what types of events are “high,” “medium,” or “low” severity. For example, event summaries indicating road closures, natural disasters, or hazardous environments may be classified as “high” severity. Road congestion or traffic slowdowns may be classified as “medium” severity, and so on. The exact classifications and application of severity to different events can vary from example-to-example.

Classifying events by severity type can help the navigation system 330 provide automatic or suggested navigation route changes through the user interface 125. For example, if an event summary along navigable route 550 is marked with “high” severity, the system 330 can automatically suggest an alternative route, or prompt the user for confirmation to remain on the same or different route. In some examples, the navigation system 330 can be configured with different levels of tolerances, e.g., to provide the same automatic or suggested route changes for “medium” severity, or in accordance with other levels of severity that may be implemented, beyond just “high,” “medium,” or “low” severity.

### Example Methods

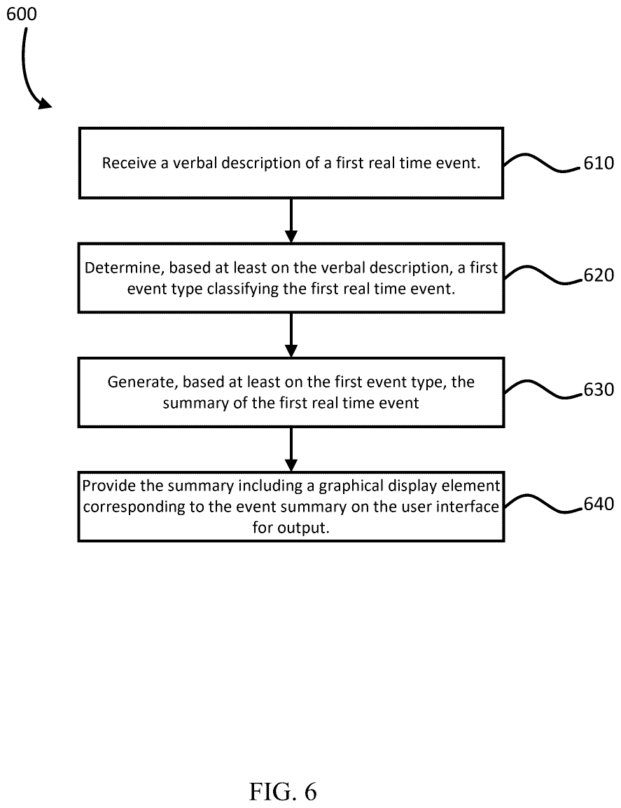

FIG. 6 is a flow diagram of an example process 600 for generating real time event summaries, according to aspects of the disclosure. The example process 600 can be performed on a system of one or more processors in one or more locations, such as the real event tracking system 100 of FIG. 1. While the operations of methods and processes are described herein in a particular order, it should be understood that the order of operations may be modified. Moreover, operations may be added or omitted.

The system receives a verbal description of a first real time event, according to block 610. The verbal description can be received, for example, through a microphone of a user computing device. The system can also receive contextual information about a navigable route, e.g., upcoming maneuvers, previous maneuvers, and so on. In some examples, the verbal description can include contextual information. In receiving the verbal description, the system can detect a predetermined hotword and record audio following the detected hotword as the verbal description.

The system determines, based at least on the verbal description, a first event type classifying the first real time event, according to block 620. The system can generate a text description from the verbal description, before consolidating available information into a prompt, for example using speech and text recognition engine 310. Prompt consolidation engine 315 can receive contextual information 110 and the text description 305 to generate a prompt 320 for the AI model 325. For example, the system can generate a predicted classification using the model 325B described herein with reference to FIG. 3. As described above, the prompt 320 can be multi-modal, e.g., including both audio and text input. In those examples, the verbal description 105 can be provided as part of the prompt 320, without first converting to a text description.

The system generates, based at least on the first event type, the summary of the first real time event, according to block 630. The system can use either the event classification model 325B or the contextual classification model 325C, for example based on whether the prompt 320 received includes both a text description of a verbal description and contextual information. In some examples, the system 100 can generate the summary without outputting a separate event classification. The system can receive contextual information associated with the contextual information, and generate the summary based at least on both the verbal description and the contextual information. The contextual information can include one or more of a current location of a computing device along a route, previous maneuvers specified in the instructions prior to reaching the current location, upcoming maneuvers specified in the instructions after reaching the current location, or information at least partially characterizing a current speed and direction of the computing device.

The system provides a graphical display element including the event summary for display or output through a user interface, according to block 640. For example, summary graphical display element 115B can be displayed on user interface 125. The user interface can be configured to display or output instructions of a navigable route to a destination. The graphical display element can include an icon generated by system 100.

Aspects of the technology relate to real time event tracking for generating and providing summaries of events reported by users along navigable routes. An example real time event can be a traffic event that is observed by a user navigating along a route provided by a navigation system. The tracking system can receive verbal descriptions of events and contextual information for a navigable route on which a user computing device in communication with the tracking system may be operated. Contextual information can be any type of information relating to the navigable route, for example previous maneuvers or upcoming maneuvers. User input may be received while a user is operating a vehicle or otherwise preoccupied and the tracking system avoids complicated and information-dense user interfaces with various predetermined user-interactable elements for event types that may be slow or hazardous to interact with and use to report an event in real time.

Implementations of the present technology can each include, but are not limited to, the following. The features may be alone or in combination with one or more other features described herein. In some examples, the following features are included in combination:
(1) A method, including: receiving, by one or more processors, a verbal description of a first real time event; determining, by the one or more processors and based at least on the verbal description, a first event type classifying the first real time event; generating, by the one or more processors and based at least on the first event type, a summary of the first real time event; and providing, by the one or more processors, a graphical display element including the summary for display or output on a user interface.
(2) The method of (1), wherein: the user interface is configured to display or output instructions of a navigable route to a destination, and providing the graphical display element includes displaying the graphical display element with an icon corresponding to the summary.
(3) The method of (2), further comprising generating, by the one or more processors, the icon based at least on the summary.
(4) The method of either (2) or (3), wherein the method further includes: receiving, by the one or more processors, contextual information associated with the navigable route; and wherein generating the summary includes generating, by the one or more processors, the summary based at least on the verbal description and the contextual information.
(5) The method of any one of (2) through (4), wherein the contextual information includes a combination of data of one or more modalities. The one or more modalities include text data, image data, video data, and/or audio data.
(6) The method of any one of (2) through (5), wherein the method further includes identifying, by the one or more processors, a position for the graphical display element along the navigable route, based at least on receiving the verbal description and the contextual information.
(7) The method of (6), wherein providing, by the one or more processors, the graphical display element for display or output comprises providing the graphical display element for display or output at the identified position along the navigable route.
(8) The method of any one of (4) through (7), wherein the contextual information includes one or more of a current location of the computing device along a route, previous maneuvers specified in the instructions prior to reaching the current location, upcoming maneuvers specified in the instructions after reaching the current location, or information at least partially characterizing a current speed and direction of the computing device.
(9) The method of any one of (1) through (8), further including: detecting, by the one or more processors, a predetermined hotword; and receiving, by the one or more processors and after detecting the predetermined hotword, audio recorded by the computing device as the verbal description.
(10) The method of any one of (1) through (9), further including: receiving, by the one or more processors, user input through a user-interactable element of the user interface; and receiving, by the one or more processors and after receiving the user input, audio recorded by the computing device as the verbal description.
(11) The method of (10), wherein generating the summary includes generating the summary in real time based on the received audio input.
(12) The method of any one of (1) through (11), wherein the user interface includes one or more user-interactable elements for reporting one or more second real time events not including the first real time event.
(13) The method of (12), wherein determining the first event type includes: generating, by the one or more processors, a prompt including text corresponding to the verbal description of the first real time event; and processing, by the one or more processors, the prompt through an artificial intelligence (AI) model trained to classify real time events based on one or more event types, wherein the one or more event types include event types that are different from event types classifying the one or more second real time events.
(14) The method of (13), wherein the graphical display element is at least partially generated by the AI model based at least on a classification of the real time event.
(15) The method of either one of (13) or (14), wherein the method further includes: converting, by the one or more processors, the verbal description to the text corresponding to the verbal description; and classifying, by the one or more processors, the prompt as not spam before processing the prompt through the AI model.
(16) The method of any one of (1) through (15), wherein generating the summary of the first real time event includes annotating an existing summary for a second real time event indicated on the user interface, wherein the annotation includes a summary of the second real time event generated for display or output through the user interface.
(17) A system including one or more processors, configured to: one or more processors configured to: receive a verbal description of a first real time event; determine, based at least on the verbal description, a first event type classifying the first real time event; generate, based at least on the first event type, a summary of the first real time event; and provide a graphical display element including the summary for display or output through a user interface.
(18) The system of (17), further configured to perform the method of any one of (1) through (16).
(19) One or more computer-readable media storing instructions that are operable, when executed by one or more processors, to cause the one or more processors to perform operations including: receiving a verbal description of a first real time event; determining, based at least on the verbal description, a first event type classifying the first real time event; generating, based at least on the first event type, the summary of the first real time event including a graphical display element for display or output on the user interface; and providing, a graphical display element including the graphical display element for display or output through a user interface.
(20) The one or more computer-readable media of (19), wherein the one or more computer-readable media is non-transitory.
(21) The one or more computer-readable media of either one of (19) or (20), wherein the operations include operations for performing the method as in any one of (1) through (16).
(22) One or more computer program products storing instructions that are operable, when executed by one or more processors, to cause the one or more processors to perform operations including: receiving a verbal description of a first real time event; determining, based at least on the verbal description, a first event type classifying the first real time event; generating, based at least on the first event type, the summary of the first real time event including a graphical display element for display or output on the user interface; and providing, a graphical display element including the graphical display element for display or output through a user interface.
(23) The one or more computer program products of (22), wherein the operations include operations for performing the method as in any one of (1) through (16).

### Example Computing Environment

FIG. 7 is a block diagram of an example computing environment 700 for implementing the real time event tracking system 100 of FIG. 1. The system 100 can be implemented on one or more devices having one or more processors in one or more locations, such as in server computing device 715. User computing device 120 and the server computing device 715 can be communicatively coupled to one or more storage devices 730 over a network 760. The storage device(s) 730 can be a combination of volatile and non-volatile memory and can be at the same or different physical locations than the computing devices 120, 715. For example, the storage device(s) 730 can include any type of non-transitory computer readable medium capable of storing information, such as a hard-drive, solid state drive, tape drive, optical storage, memory card, ROM, RAM, DVD, CD-ROM, write-capable, and read-only memories.

Aspects of the disclosure can be implemented in a computing system that includes a back-end component, e.g., as a data server, a middleware component, e.g., an application server, or a front-end component, e.g., user computing device 120 having a user interface, a web browser, or an app, or any combination thereof. The components of the system can be interconnected by any form or medium of digital data communication, such as a communication network. Examples of communication networks include a local area network (LAN) and a wide area network (WAN), e.g., the Internet. The datacenter 721 can also be in communication with the user computing device 120 and the server computing device 715.

The computing system can include clients, e.g., user computing device 120 and servers, e.g., server computing device 715. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

The server computing device 715 can include one or more processors 713 and memory 714. The memory 714 can store information accessible by the processor(s) 713, including instructions 721 that can be executed by the processor(s) 713. The memory 714 can also include data 723 that can be retrieved, manipulated, or stored by the processor(s) 713. The memory 714 can be a type of non-transitory computer readable medium capable of storing information accessible by the processor(s) 713, such as volatile and non-volatile memory. The processor(s) 713 can include one or more central processing units (CPUs), graphic processing units (GPUs), field-programmable gate arrays (FPGAs), and/or application-specific integrated circuits (ASICs), such as tensor processing units (TPUs).

The instructions 721 can include one or more instructions that when executed by the processor(s) 713, causes the one or more processors to perform actions defined by the instructions. The instructions 721 can be stored in object code format for direct processing by the processor(s) 713, or in other formats including interpretable scripts or collections of independent source code modules that are interpreted on demand or compiled in advance. The instructions 721 can include instructions for implementing the system 100 consistent with aspects of this disclosure. The system 100 can be executed using the processor(s) 713, and/or using other processors remotely located from the server computing device 715.

The data 723 can be retrieved, stored, or modified by the processor(s) 713 in accordance with the instructions 721. The data 723 can be stored in computer registers, in a relational or non-relational database as a table having a plurality of different fields and records, or as JSON, YAML, proto, or XML documents. The data 723 can also be formatted in a computer-readable format such as, but not limited to, binary values, ASCII, or Unicode. Moreover, the data 723 can include information sufficient to identify relevant information, such as numbers, descriptive text, proprietary codes, pointers, references to data stored in other memories, including other network locations, or information that is used by a function to calculate relevant data.

The user computing device 120 can also be configured similar to the server computing device 715, with one or more processors 716, memory 717, instructions 718, and data 719. For example, the user computing device 120 can be a mobile device, a laptop, a desktop computer, a game console, etc. The user computing device 120 can also include a user output 726, and a user input 724. The user input 724 can include any appropriate mechanism or technique for receiving input from a user, including acoustic input; visual input; tactile input, including touch motion or gestures, or kinetic motion or gestures or orientation motion or gestures; auditory input, speech input, etc., Example devices for user input 724 can include a keyboard, mouse or other point device, mechanical actuators, soft actuators, touchscreens, microphones, and sensors. Instructions 718 can include navigation software application 335, for example as described herein with reference to FIG. 3.

In some examples, the user computing device 120 can be a vehicle, such as vehicle 170, connected to vehicle 170, or integrated as a component of the vehicle 170, such as part of a console display. The vehicle 170 can be configured for manual operation, autonomous operation, remote operation, or a combination of the preceding.

The server computing device 715 can be configured to transmit data to the user computing device 120, and the user computing device 120 can be configured to display at least a portion of the received data on a display implemented as part of the user output 726. The user output 726 can also be used for displaying an interface between the user computing device 120 and the server computing device 715. The user output 726 can alternatively or additionally include one or more speakers, transducers or other audio outputs, a haptic interface or other tactile feedback that provides non-visual and non-audible information to the platform user of the user computing device 120.

Although FIG. 7 illustrates the processors 713, 716 and the memories 714, 717 as being within the computing devices 715, 120, components described in this specification, including the processors 713, 716 and the memories 714, 717 can include multiple processors and memories that can operate in different physical locations and not within the same computing device. For example, some of the instructions 721, 718 and the data 723, 719 can be stored on a removable SD card and others within a read-only computer chip. Some or all of the instructions and data can be stored in a location physically remote from, yet still accessible by, the processors 713, 716. Similarly, the processors 713, 716 can include a collection of processors that can perform concurrent and/or sequential operation. The computing devices 715, 120 can each include one or more internal clocks providing timing information, which can be used for time measurement for operations and programs run by the computing devices 715, 120.

The server computing device 715 can be configured to receive requests to process data from the user computing device 120. For example, the environment 700 can be part of a computing platform configured to provide a variety of services to users, through various user interfaces and/or application programming interface (APIs) exposing the platform services. One or more services can be a machine learning framework or a set of tools for training or executing generative models or other machine learning models according to a specified task and training data.

The devices 120, 715 can be capable of direct and indirect communication over the network 760. The devices 715, 120 can set up listening sockets that may accept an initiating connection for sending and receiving information. The network 760 itself can include various configurations and protocols including the Internet, World Wide Web, intranets, virtual private networks, wide area networks, local networks, and private networks using communication protocols proprietary to one or more companies. The network 760 can support a variety of short-and long-range connections. The short-and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 760, in addition or alternatively, can also support wired connections between the devices 120, 715, including over various types of Ethernet connection.

Although a single server computing device 715, user computing device 120, and datacenter 757 are shown in FIG. 7, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Datacenter 757 can house one or more hardware accelerators 731 on which the deployed models will execute for real time event reporting, according to aspects of the disclosure. The hardware accelerators 731 can be any type of processor, such as a central processing unit (CPU), graphics processing unit (GPU), field-programmable gate array (FPGA), or an application-specific integrated circuit (ASIC), such as a tensor processing unit (TPU).

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more engines or modules of computer program instructions encoded on one or more tangible non-transitory computer storage media for execution by, or to control the operation of, one or more data processing apparatus.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” or “software application” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” can refer to a software-based system, subsystem, or process that is programmed to perform one or more specific functions. The engine can be implemented as one or more software modules or components or can be installed on one or more computers in one or more locations. A particular engine can have one or more processors or computing devices dedicated thereto, or multiple engines can be installed and running on the same processor or computing device. In some examples, an engine can be implemented as a specially configured circuit, while in other examples, an engine can be implemented in a combination of software and hardware.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers. While operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all examples, and it should be understood that the described program components and systems can be integrated together in one or more software or hardware-based devices or computer-readable media.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, desktop computer, a personal digital assistant (PDA), a mobile audio or video player, a game console, a tablet, a virtual-reality (VR) or augmented-reality (AR) device, a Global Positioning System (GPS), or a portable storage device, e.g., a universal serial bus (USB) flash drive, as examples. Examples of the computer or special purpose logic circuitry can include the user computing device 120, the server computing device 715, or the hardware accelerators 777.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof. A computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus. A computer program may, but need not, correspond to a file in a file system. A computer program can be stored in a portion of a file that holds other programs or data, e.g., one or more scripts, in a single file, or in multiple coordinated files, e.g., files that store one or more engines, modules, sub-programs, or portions of code.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible examples. Further, the same reference numbers in different drawings can identify the same or similar elements.

1. A method, comprising:
receiving, by one or more processors, a verbal description of a first real time event;
determining, by the one or more processors and based at least on the verbal description, a first event type classifying the first real time event;
generating, by the one or more processors and based at least on the first event type, a summary of the first real time event; and
providing, by the one or more processors, a graphical display element comprising the summary for display or output on a user interface.

2. The method of claim 1, wherein:
the user interface is configured to display or output instructions of a navigable route to a destination, and
providing the graphical display element comprises displaying the graphical display element with an icon corresponding to the summary.

3. The method of claim 2, further comprising generating, by the one or more processors, the icon based at least on the summary.

4. The method of claim 2, wherein the method further comprises:
receiving, by the one or more processors, contextual information associated with the navigable route; and
wherein generating the summary comprises generating, by the one or more processors, the summary based at least on the verbal description and the contextual information.

5. The method of claim 4, wherein the contextual information comprises data of one or more modalities, and further comprises one or more of a current location of the computing device along a route, previous maneuvers specified in the instructions prior to reaching the current location, upcoming maneuvers specified in the instructions after reaching the current location, or information at least partially characterizing a current speed and direction of the computing device.

6. The method of claim 4, further comprising:
identifying, by the one or more processors, a position for the graphical display element along the navigable route, based at least on receiving the verbal description and the contextual information; and
wherein providing, by the one or more processors, the graphical display element for display or output comprises providing the graphical display element for display or output at the identified position along the navigable route.

7. The method of claim 1, further comprising:
receiving, by the one or more processors, user input through a user-interactable element of the user interface; and
receiving, by the one or more processors and after receiving the user input, audio recorded by the computing device as the verbal description.

8. The method of claim 1, wherein the user interface comprises one or more user-interactable elements for reporting one or more second real time events not including the first real time event.

9. The method of claim 8, wherein determining the first event type comprises:
generating, by the one or more processors, a prompt comprising text corresponding to the verbal description of the first real time event; and
processing, by the one or more processors, the prompt through an artificial intelligence (AI) model trained to classify real time events based on one or more event types, wherein the one or more event types comprise event types that are different from event types classifying the one or more second real time events.

10. The method of claim 9, wherein the graphical display element is at least partially generated by the AI model based at least on a classification of the real time event.

11. The method of claim 9, wherein the method further comprises:
converting, by the one or more processors, the verbal description to the text corresponding to the verbal description; and
classifying, by the one or more processors, the prompt as not spam before processing the prompt through the AI model.

12. The method of claim 11, further comprising:
receiving, by the one or more processors, user input through a user-interactable element of the user interface; and
receiving, by the one or more processors, audio recorded by the computing device as the verbal description, after receiving the user input.

13. The method of claim 12, wherein generating the summary comprises generating the summary in real time based on the received audio input.

14. A system, comprising:
one or more processors configured to:
receive a verbal description of a first real time event;
determine, based at least on the verbal description, a first event type classifying the first real time event;
generate, based at least on the first event type, a summary of the first real time event; and
provide a graphical display element comprising the summary for display or output through a user interface.

15. The system of claim 14, wherein:
the user interface is configured to display or output instructions of a navigable route to a destination, and
in providing the graphical display element, the one or more processors are configured to display the graphical display element with an icon corresponding to the summary.

16. The system of claim 15, wherein:
the one or more processors are further configured to receive contextual information associated with the navigable route; and
wherein in generating the summary, the one or more processors are configured to generate, by the one or more processors, the summary based at least on the verbal description and the contextual information.

17. The system of claim 16, wherein the contextual information comprises data of one or more modalities and comprises one or more of a current location of the computing device along a route, previous maneuvers specified in the instructions prior to reaching the current location, upcoming maneuvers specified in the instructions after reaching the current location, or information at least partially characterizing a current speed and direction of the computing device.

18. The system of claim 14, wherein the one or more processors are further configured to:
receive user input through a user-interactable element of the user interface; and
receive audio recorded by the computing device as the verbal description, after receiving the user input.

19. The system of claim 18, wherein the one or more processors are configured to generate the summary in real time based on the received audio input.

20. One or more non-transitory computer-readable media storing instructions that are operable, when executed by one or more processors, to cause the one or more processors to perform operations comprising:
receiving a verbal description of a first real time event;
determining, based at least on the verbal description, a first event type classifying the first real time event;
generating, based at least on the first event type, the summary of the first real time event comprising a graphical display element for display or output on the user interface; and
providing, a graphical display element comprising the graphical display element for display or output through a user interface.
